(19) United States
(12) Patent Application Publication
(10) Pub. No.: US 2024/0122804 A1
(43) Pub. Date: Apr. 18, 2024

(54) Massager Cover

(71) Applicant: MerchSource, LLC, Irvine, CA (US)

(72) Inventor: Denny SzuPao Liao, Tustin, CA (US)

(21) Appl. No.: 18/375,511

(22) Filed: Sep. 30, 2023

Related U.S. Application Data
(63) Continuation of application No. 29/856,801, filed on Oct. 17, 2022.
Application No. 29/856,801 is a continuation of application No. 29/856,806, filed on Oct. 17, 2022.

(51) Int. Cl. A61H 99/00

(52) U.S. Cl. CPC A61H 99/00; A61H 2201/0161; A61H 2205/12

(57) ABSTRACT

A massager cover for covering a massager housing with massage openings on at least one side of the massager housing. The massager cover includes a first panel section positioned to cover the side of the massager housing having massage openings when the first panel section is in a first position. A second panel section is joined with the first panel section and affixed to a side of the massager housing adjacent to the side having massage openings. The first and second panel sections are articulated and moveable between and first and second position, where the first panel section is positioned on top of the second panel section when in the second position. A fastener is further included for removably securing the first panel section on top of the second panel section when the first panel section is moved from the first position to the second position. The fastener may be magnets included in both panels as well as on the massager housing for removably securing the first panel section to both the massager housing when in a first position and the second panel section when in a second position.

### CROSS REFERENCE TO RELATED APPLICATIONS

This application is a continuation of and claims priority to U.S. Design patent application Ser. No. 29/856,801, filed on Oct. 17, 2022, titled Foot Massager and to U.S. Design patent application Ser. No. 29/856,806, filed on Oct. 17, 2022, and titled Foot Massager, both applications of which are incorporated by reference into this application in their entirety.

### FIELD OF INVENTION

This invention relates to a cover and, in particular, a massager cover for covering a foot massager.

### BACKGROUND

Foot massagers are generally bulky appliances that include a housing having at least two openings for receiving and massaging a user's feet. When not in use, the two openings generally remain exposed, and the massager remains unsightly and unusable for anything other than a foot massager. Foot massagers take up a lot of space and can be difficult to store. Further, when not in use, the openings in the foot massagers attract dust and other particles which are not easily removed from the openings in the foot massagers. A need exists for a foot massager with openings that are easily covered without adding additional bulk to the foot massager. A further need exists for a foot massager that can be used for something other than a massager when not in use as a massager. Yet a further need exists for a foot massager that can be stored in a manner that does not take up a lot of space.

### SUMMARY

A massager cover for covering a massager housing having at least five sides with massage openings on at least one of the sides of the massager housing. The massager cover includes a first flap section positioned to cover the side of the massager housing having massage openings when the first flap is in a first position. A securing panel is joined with the first flap section and affixed to a side of the massager housing adjacent to the side having massage openings. The first flap and securing panel are articulated and moveable between and first and second position, where the first flap section is positioned on top of the securing panel when in the second position. A fastener is further included for removably securing the first flap on top of the securing panel when the first flap is moved from the first position to the second position.

In one example, the fastener may be magnets included in either the first flap or the securing panel or both. In another example, the fastener may be a hook and loop type fastener or a securing strap for securing the first flap against the securing panel. The securing strap may be positioned across the first flap section when it is on top of the securing panel and secured against the massager housing by at least one button, snap or hood and loop fastener.

A massager cover for covering a massager housing having at least five sides with massager openings on at least a one side of the massager housing, the massager cover comprising: at least two articulated panel sections positioned to cover the at least one side of the massager housing when in a first position; a securing panel joined with at least one of the at least two articulated panel sections, where the securing panel is affixed to a side of the massager housing adjacent to the at least one side of the massager housing having massager openings, where the securing panel and at least two articulated panel sections are all articulated; and a fastener for securing the at least two panel section on top of the securing panel when the at least two panel sections are moved from the first position to a second position.

In another example, a foot massager is provided that includes a massager housing having a top surface, bottom side, front side and back side, where the top surface includes massage opening for receiving a user's feet to impart a massage effect on the user's feet. The foot massager further includes at least one cover panel for covering the top surface of the massager housing and covering the massage openings when the at least one cover panel is in the first position, where the at least one cover panel includes either a magnet or magnetic attracting material. At least one securing panel is also provided on the back side of the massager, where the at least one securing panel includes either a magnet or magnetic attracting material. A flexible material extends between the at least one cover panel and the at least one securing panel such that the at least one cover panel and the at least one securing panel are articulated, and where the at least one cover panel can move from a first position to a second position where the at least one cover panel is position over the at least one securing panel in the second position and removably secured to the at least one securing panel by the magnets or magnetic attracting material in the at least one cover panel and the at least one securing panel.

In all cases, at least one cover panel, first panel or flap section and the at least one securing panel or second panel are flat panels. The massager may further include a handle on the front side of the massager. The top surface of the massager housing may also include either a magnet or magnetic attracting material for removably securing the at least one cover panel, first panel or flap section to the top surface of the massager housing when in first position. The back side may be straight such that the massager may be stored in an upright position.

In all cases, the fastener may be magnets included in either the first flap or the securing panel or both. In another example, the fastener may be a hook and loop type fastener or a securing strap for securing the first flap against the securing panel. The securing strap may be positioned across the first flap section when it is on top of the securing panel and secured against the massager housing by at least one button, snap or hook and loop fastener.

Other devices, apparatus, systems, methods, features and advantages of the invention are or will become apparent to one with skill in the art upon examination of the following figures and detailed description. It is intended that all such additional systems, methods, features and advantages be included within this description, be within the scope of the invention, and be protected by the accompanying claims.

### DESCRIPTION OF FIGURES

The invention may be better understood by referring to the following figures. The components in the figures are not necessarily to scale, emphasis instead being placed upon illustrating the principles of the invention.

FIG. 1 is a top, front perspective view of the foot massager having a cover positioned over the foot massage openings.

FIG. 2 is a rear, bottom perspective view of the foot massager of FIG. 1.

FIG. 3 is a side perspective view of the foot massager of FIG. 1.

FIG. 4 is a top rear perspective view of the foot massager of FIG. 1 with the cover removed.

FIG. 5 is a side perspective view of the foot massager of FIG. 1 showing the cover being removed and the massager in use by a user.

FIG. 6 is a side perspective view of the foot massager of FIG. 1 with the cover placed over the massager openings and with the massager being stored upright.

### DESCRIPTION OF THE INVENTION

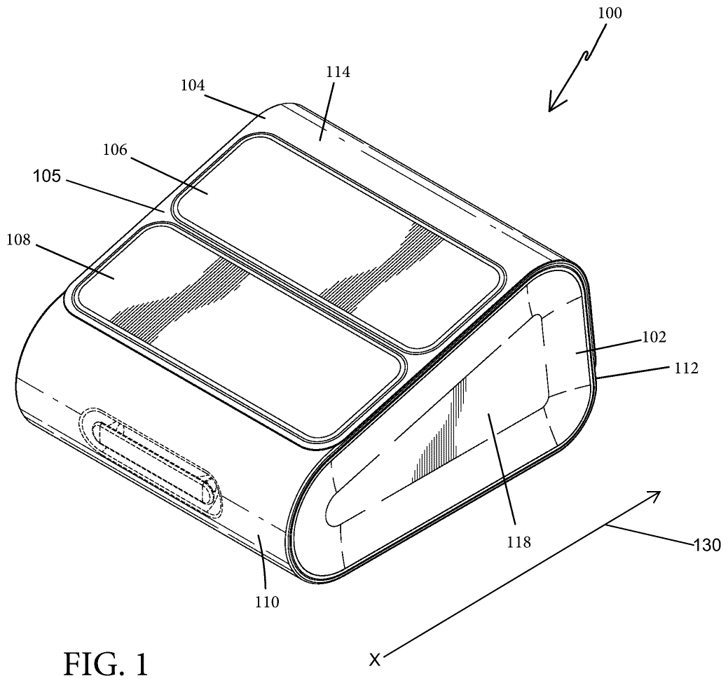

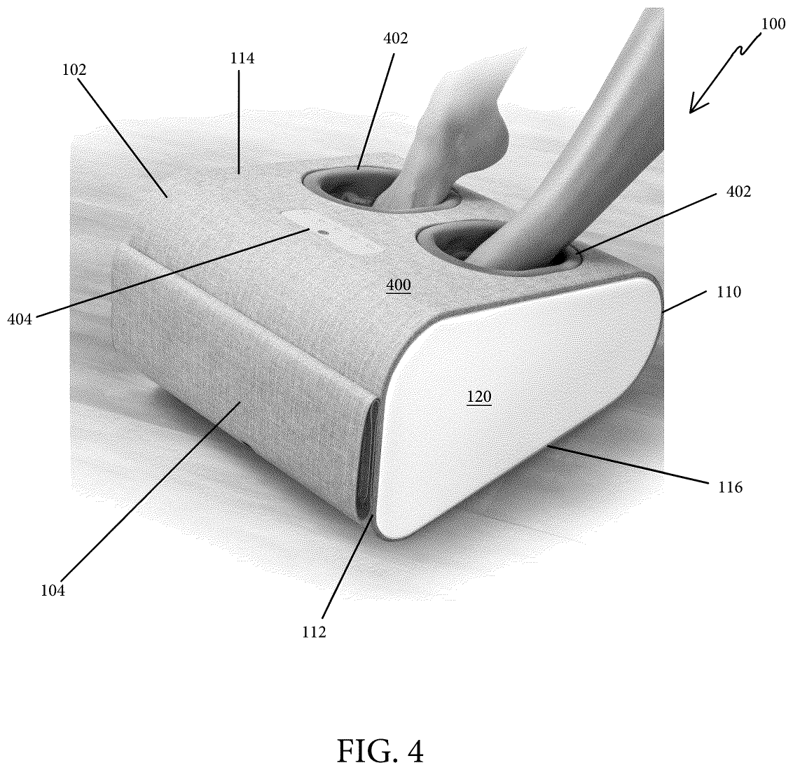

As illustrated in the attached FIGS. 1-6, the present invention relates to foot massager 100 having a massager body or housing 102 and a flat cover 104 for covering massager openings 402 (FIG. 4) on at least one side of the foot massager 100. Massager 100 may be a box shaped or wedged shaped massager having massager openings for a user's feet. Massage nodes and motors are housed within massager housing 102 for massaging a user's feet. When not in use, the foot massager 100 with cover 104 can act as a footrest or may be stored in an upright position to save floor space. For storage and use as a footrest, it may be more desirable for the top of the massager 100 to slant in one direction with the resulting lower side being the front of the massager 100 where the user inserts his or her feet into the opening 402 in the massager 100.

For purposes of reference and description, the massager 100 is considered to have a massager axis-x 130 (FIG. 1) along which the components of the massager 100 are positioned relative to each other. Terms such as “axial” and “axially” are assumed to refer to the massager axis 130 or any direction or axis parallel to the massager axis 130, unless indicated otherwise or the context dictates otherwise. In this disclosure, the plane orthogonal to the massager axis 130 is referred to as the transverse plane. For convenience, movement relative to the massager axis 130 may alternatively encompass movement relative to an axis that is parallel to the massager axis 130 that is specifically illustrated in FIG. 1, unless the context dictates otherwise. Thus, linear translation “along the massager axis 130” is not limited to translation directly on (coincident with) the massager axis 130, but also encompasses translation parallel to the massager axis 130, depending on the context. Similarly, rotation “about the massager axis 130” also encompasses rotation about an axis that is parallel to the massager axis 130, depending on the context. In one example and as illustrated, the massager axis 130 may be oriented generally parallel to the surface upon which the massager 100 rests (e.g., floor).

FIG. 1 is a top, front perspective view of the foot massager 100 having a cover 104 positioned over the foot massage openings 402. The foot massager 100 includes a massager body (a/k/a massager housing) 102, which in this illustration is wedged shaped. The massager body 102 includes (i) a front side 110, which in this illustration is rounded, (ii) a back side 112, (iii) a top side 114 which is slanted downward from the back side 112 to the front side 110, (iv) a bottom side 116, (v) a right side 118 (of the massager 110) and (vi) a left side 120. The wedge shape illustrated in FIGS. 1-6 is provided for example only. Other shapes may be used without departing from the scope of the invention which may also include a slanted top side 114, which could converge at the front side 110 in a point, straight vertical side or other shape. Further, the top side 114 or other sides of the massager 100 could be slightly rounded or flat without departing from the scope invention.

A massager cover 104 for covering the top side 114 or top surface 400 (FIG. 4) of the massager body 102 is also provided. The massager cover 104 functions to cover the massage openings 402 on the top side 114 of the massager housing 102. The massager cover 104 includes a flap section or cover panel 105 positioned over the side of the massager housing 102 having massage openings 402. As shown, flap section 105 may also include one or more panel sections 106, 108. The panel sections 106 and 108 articulate such that one panel section 108 can fold on top of the other panel section 108. The flap section 105 is in a first position or closed position when the flap section 105 is on top of the top surface 400 (FIG. 4) of the massager body 102 to cover the massage openings 402.

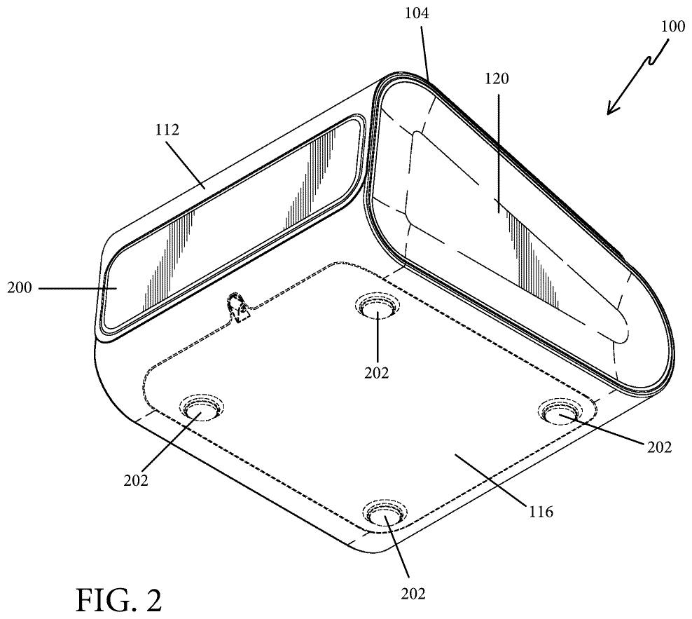

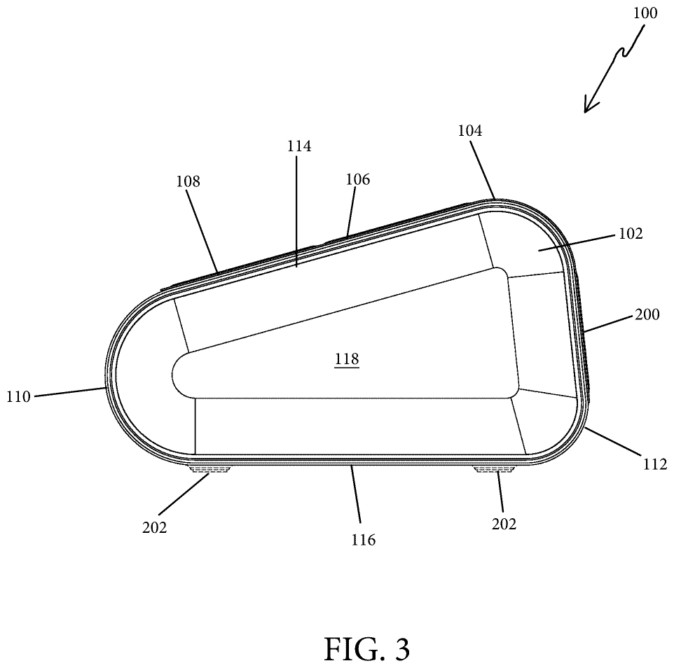

Turning now to FIG. 2, which is a rear, bottom perspective view of the foot massager 100 and FIG. 3, which is a side perspective view of the foot massager 100. A securing panel 200 is joined with the first flap section 105, in an articulated manner, and affixed to the rear side 112 of the massager housing 102 adjacent to the massage openings 402. The securing panel 200 may optionally be removably affixed to the massager housing 102; however, it is more desirable to have the securing panel 200 permanently affixed to the massager housing 102 so that the massager cover 104 remains connected to the massager housing 100 and does not get misplaced.

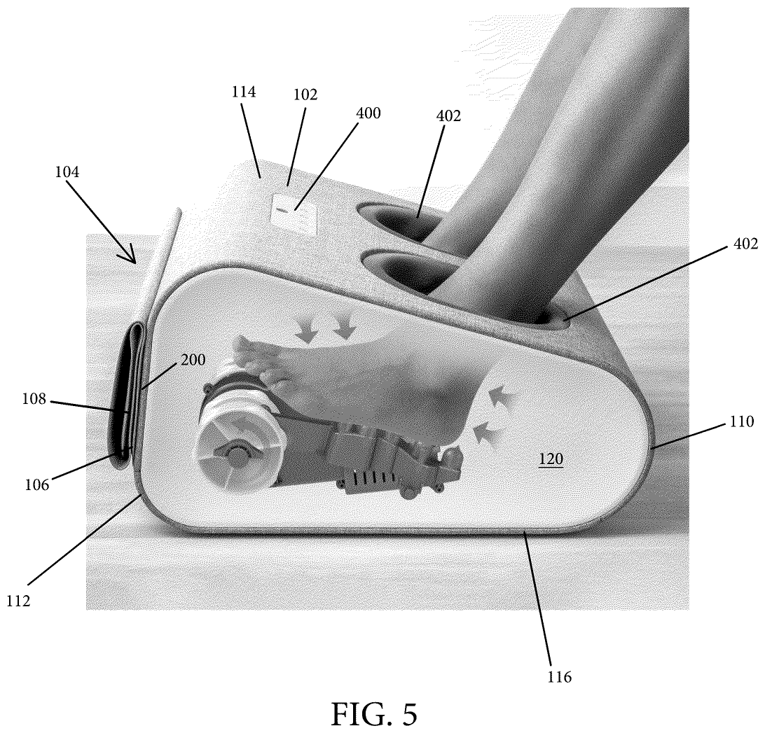

The first flap 105 and securing panel 200 are articulated and moveable between and first or closed position and second or open position (as shown in FIG. 4-5 and further described below). In the open position, the first flap 105 is held against the securing panel 200 to expose the massager openings 402 for use. The panel sections 106, 108 and securing panel 200 may all be approximately the same size such that they can stack on top of one another when in a second or open position as described further below in connection with FIGS. 4-5.

Also as seen in FIGS. 2 & 3 are feet 202 positioned on the bottom side 116 of the massager housing 102 for supporting the massager 100 on a surface, such as the floor, in a manner that prevents the slipping of the massager 100 across the surface. Alternatively, although not shown, a gripping pad, rubber bottom, rails or other supports may also be used in place of the feet 202.

FIG. 4 is a top rear perspective view of the foot massager of FIG. 1 with the cover 104 removed from the top side 114 of the massager 100 to expose the massage openings 402 positioned on the top surface 400 of the massager housing 102. As shown, in a second, open position, the first flap section 105 is positioned atop the securing panel 200. When the flap section 105 includes more than one panel 106, 108, the panels 106, 108 may be folded on top of one another and then secured against the securing panel 200. The securing panel and the flap section 105 may include magnetics. Or, the flap section or securing panel 200 may include a magnet, where the other includes ferromagnetic material securing the flap section 105 against the securing panel 200.

When the flap section 105 includes more than one panel 106, 108, where one folds over the other, the panel 106, 108 positioned directly adjacent to the securing panel 200 when folded over and positioned in a second, open position may include the magnetic or ferromagnetic material to secure the flap section 105 against the securing panel 200. As shown, flexible material extends between panels 106, 108, 200 which allow for panels 106, 108 & 200 to articulate.

FIG. 5 is a side perspective view of the foot massager of FIG. 1 showing the cover 104 removed from the top surface 400 of the massager housing 102, with the massager 100 in use by a user. FIG. 5 best shows, when in the open position, panel section 108 folds over panel 106, which are then both rotated together to flip over to the back side 112 of the massager housing 102 and contact the securing panel 200. Here, panel 106 ends up adjacent to the securing panel 200. While both panels 106 and 108 may include ferromagnetic material and the securing panel 200 including a magnet, panel 106 may optionally including either a magnet or ferromagnetic material with panel 108 having no magnetic or magnetic attracting properties. Those skilled in the art will recognize different configurations of equivalent magnets and/or ferromagnetic materials to removably secure the flap section 105 and/or panels 106, 108 to the securing panel 200. When using magnets or magnetically attracting materials, the magnets and/or magnet attracting material are positioned within one or more panels 106, 108 of the flap section 105 and within the securing panel 200. The flexible material that extends between the panels 106, 108, 200 and which allow for the panels 106, 108, 200 to articulate may be devoid of such material to make articulation easier.

While magnets may be used to secure the flap section 105 against the securing panel 200, those skilled in the art will recognize that other fasteners may be use for removably securing the flap section 105 to the securing panel 200 when the flap section 105 is moved from the first position to the second position. For example, the fastener may be a hook and loop type fastener or a securing strap for securing the first flap against the securing panel. Alternatively, Velcro® may be used, a strap with at least one button, snap, fastener that extends from or over the securing panel 200 and flap section 105 to hold the two together against one another.

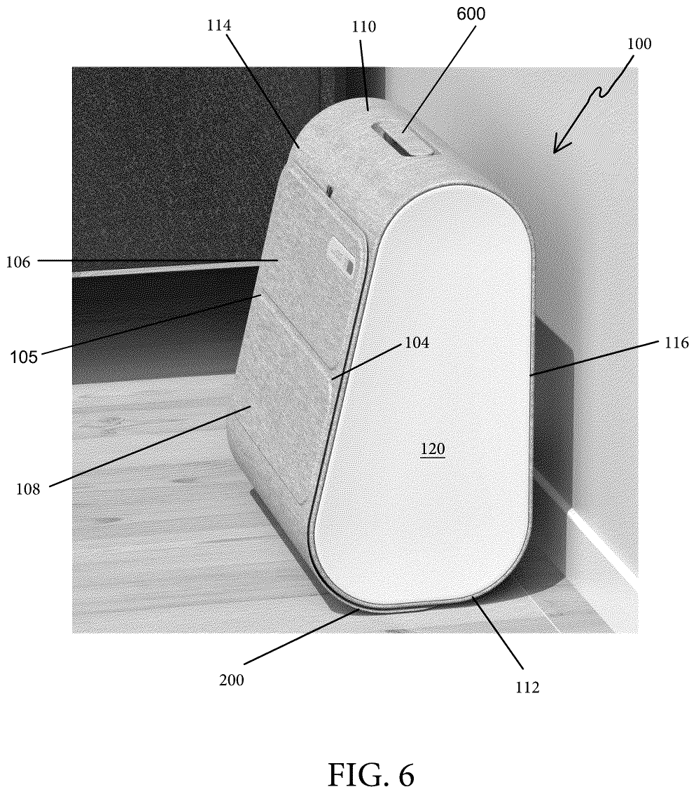

As shown in FIG. 6, which is a side perspective view of the foot massager of FIG. 1 with the massager 100 being supported on its back side 112. For purposes of storage, flap section 105 may be placed over the massage openings 402. To keep the flap section 105 in place, the massager housing 102 may further include magnets and/or ferromagnetic material for removeable securing the flap section 105 against the top surface 400 of the massager housing 102. Alternatively, snaps, Velcro® or other known fasteners used to secure two substrates together may be used.

Cover 104 is comprised of one or more panels 106, 108 and 200 that are all flat panels, creating streamline and smooth cover that fits to the contour of the massager body 102. In this matter, the cover is not bulky and does not add to the size of the massager 100. Rather, it protects the massager 100 and the massage openings 402 and makes the use of the massager 100. With the cover 104 over the top surface 400 of the massager housing 102, the massager 100 can be used as a footrest or alternatively, by including a generally flat back side 112, the massager can be stored upright, minimizing the amount of floor space consumed during storage. The massager 100 may further include a handle 600 on its front side 110 for carrying the massager 100 for the ease of transportation and storage.

In summary, massager cover 102 includes at least one first a panel section 106, 108 positioned to cover the side of the massager housing 102 having massage openings 402 when the at least one panel section 106, 108 is in a first position. Massager cover 102 further includes at least one second panel section 200 connected to the side of the massager housing 102 adjacent to the side having massage openings 402. The at least one first and at least one second panel sections 106, 108 and 200 having flexible material positioned between the panels 106, 108, 200 such that the at least one first and second panels 106, 108 and 200 are articulated between one another and easily moveable between and first and second position, where the at least one first panel section 106, 108 is positioned on top of the at least one second panel section 200 when in the second position. A fastener is further included for removably securing the first panel section 106, 108 on top of the second panel section 200 when the first panel section 106, 108 is moved from the first position (FIG. 1) to the second position (FIG. 4).

In one example, the fastener may be magnets (or a magnet and ferromagnetic material) included in the at least one first 106, 108 and at least one second panels 200. In another example, the fastener may be alternative fasteners as further described above.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

I claim:

1. A foot massager comprising:
a massager housing having a top surface, bottom side, front side and back side, where the top surface includes massage opening for receiving a user's feet to impart a massage effect on the user's feet;
at least one cover panel for covering the top surface of the massager housing and covering the massage openings when the at least one cover panel is in the first position, where the at least one cover panel includes either a magnet or magnetic attracting material;
at least one securing panel on the back side of the massager, where the at least one securing panel includes either a magnet or magnetic attracting material; and
a flexible material extending between the at least one cover panel and the at least one securing panel such that the at least one cover panel and the at least one securing panel are articulated, and where the at least one cover panel can move from a first position to a second position where the at least one cover panel is position over the at least one securing panel in the second position and removably secured to the at least one securing panel by the magnets or magnetic attracting material in the at least one cover panel and the at least one securing panel.

2. The foot massager of claim 1 where the at least one cover panel and the at least one securing panel are flat panels.

3. The foot massager of claim 1 further including a handle on the front side of the massager housing.

4. The foot massager of claim 1 where the top surface of the massager housing also includes either a magnet or magnetic attracting material for removably securing the at least one cover panel to the top surface of the massager housing when in first position.

5. A massager cover for covering a massager housing having at least six sides with massager openings on at least a one side of the massager housing, the massager cover comprising:
a first panel section positioned to cover the at least one side of the massager housing having massager openings when in a first position;
a second panel section joined with the first panel section, where the second panel section is affixed to a side of massager housing adjacent to the at least one side of the massager housing having massager openings, where the first and second panel sections are articulated; and
a fastener for securing the first panel section on top of the second panel section when the first panel section is moved from the first position to a second position.

6. The massager cover of claim 5 where the fastener is magnets included in the first and second panels.

7. A massager cover for covering a massager housing having at least six sides with massager openings on at least a one side of the massager housing, the massager cover comprising:
at least two articulated panel sections positioned to cover the at least one side of the massager housing having massager openings when in a first position;
a third panel section joined with at least one of the at least two articulated panel sections, where the third panel section is affixed to a side of the massager housing adjacent to the at least one side of the massager housing having massager openings, where the third panel and at least two articulated panel sections are articulated; and
a fastener for securing the at least two panel section on top of the third panel section when the at least two panel sections are moved from the first position to a second position.

8. The massager cover of claim 7 where the fastener is magnets included in the first and second panels.
